(19) United States
(12) Patent Application Publication
(10) Pub. No.: US 2026/0184379 A1
(43) Pub. Date: Jul. 2, 2026

(54) VEHICLE BODY UNIT AND VEHICLE BODY AND VEHICLE

(71) Applicants: Miriam Rommel, Dettingen (DE); Marco Schrade, Dettingen (DE); Philipp Streicher, Dettingen (DE); Gerd Traxler, Dettingen (DE); Simon Steffan, Dettingen (DE); Torsten Stifel, Dettingen (DE)

(72) Inventors: Miriam Rommel, Dettingen (DE); Marco Schrade, Dettingen (DE); Philipp Streicher, Dettingen (DE); Gerd Traxler, Dettingen (DE); Simon Steffan, Dettingen (DE); Torsten Stifel, Dettingen (DE)

(73) Assignee: ElringKlinger AG, Dettingen (DE)

(21) Appl. No.: 19/530,102

(22) Filed: Feb. 4, 2026

Related U.S. Application Data
(63) Continuation of application No. PCT/EP2024/070926, filed on Jul. 23, 2024.

(30) Foreign Application Priority Data
Aug. 7, 2023 (DE) 10 2023 120 955.8

(51) Int. Cl. B62D 25/14; B62D 29/00

(52) U.S. Cl. CPC B62D 25/14; B62D 29/004

(57) ABSTRACT

A vehicle body unit (210), having at least one support element (212) extending in particular longitudinally, at least one injection molding element (214) and at least one functional element (310). The invention proposes that at least one functional element (310), in particular with a retaining part (312), is arranged at least partially in contact with the at least one support element (212) and that at least one retaining part (362) of at least one injection molding element (214) is at least partially molded onto the at least one support element (212) and the at least one adjacently arranged functional element (310).

### CROSS-REFERENCE TO RELATED PATENT APPLICATIONS

This patent application is a continuation of International Application No. PCT/EP 2024/070926, filed on Jul. 23, 2024, which claims the benefit of priority to German Patent Application No. 102023120955.8, filed Aug. 7, 2023, the entire teachings and disclosures of both applications are incorporated herein by reference thereto.

### FIELD OF THE INVENTION

The invention relates to a vehicle body unit, a vehicle body and a vehicle.

### BACKGROUND OF THE INVENTION

The object underlying the invention is to improve a vehicle body unit and a vehicle body and a vehicle.

### BRIEF SUMMARY OF THE INVENTION

In embodiments of the invention, this object is achieved by a vehicle body unit comprising at least one support element which in particular extends longitudinally, at least one injection molding element and at least one functional element, wherein at least one functional element, in particular with a retaining part of this at least one functional element, is arranged at least partially in contact with the at least one support element, and at least one retaining part of at least one injection molding element is at least partially molded onto the at least one support element and the at least one adjacently arranged functional element.

Preferably, the retaining part is at least partially molded onto the retaining part of the at least one adjacently arranged functional element. This advantageously keeps the retaining part and the support element in the adjacent arrangement.

In particular, an advantage of the solution according to the invention is that a stable design of the vehicle body unit can be achieved by the adjacent arrangement of the at least one functional element on the support element. In particular, the attachment of the at least one functional element arranged in contact with the support element is stabilized by the contact.

In particular, an advantage of the solution according to the invention is that by forming the retaining part onto the at least one adjacently arranged functional element and onto the support element, these two elements can be fixed to each other in a structurally simple manner.

For example, one advantage of the solution according to the invention is that the production of the vehicle body unit is improved, in particular simplified and/or made more cost-effective.

In particular, during manufacturing, the support element and the functional element can be inserted into a mold as inserts, wherein the functional element is advantageously already partially and preferably predominantly correctly positioned relative to the support element by means of the adjacent arrangement, and the support element and the functional element are fixed in the adjacent arrangement by molding on the at least one injection molding element.

In some advantageous embodiments, the injection molding element with at least one retaining part forms further components and/or parts, thus allowing functional integration in an advantageous manner.

No further details have yet been provided regarding other advantageous embodiments of the adjacent arrangement.

It is particularly advantageous if at least one functional element, in particular with the retaining part thereof, is arranged in contact with the support element along a force flow path provided in the vehicle body unit.

This is particularly advantageous because the force flow path then runs through the adjacent arrangement. In particular, this at least reduces the risk of breakage along the force flow path, because the force acting along the force flow path is transferred at the transition between the support element and the functional element along the adjacent portions.

It is particularly advantageous if the adjacently arranged portions of the functional element and the support element face each other in a direction in which the force acts along the force flow path. Advantageously, such a load acts on the corresponding sides at least approximately in the direction of the normals of these adjacent sides due to the force acting along the force flow path, and advantageously, shear forces between the functional element and the support element are thus at least reduced.

Advantageously, the at least partially adjacent arrangement of at least one functional element on the support element establishes a relative position between the at least one functional element and the support element in at least one orientation of at least one spatial direction.

This is particularly advantageous because it simplifies the production of the vehicle body unit, as the functional element is already positioned in the correct relative position at least in one spatial direction.

In particular, this allows for a stable design of the vehicle body unit because the adjacent arrangement holds the functional element and the support element at least partially in their intended relative position and thus, advantageously, even when the vehicle body unit is under stress, these elements remain in the defined relative position. In particular, stresses on the vehicle body unit are absorbed by the adjacent arrangement and the elements remain in the defined relative position.

In particular, the relative position can be at least partially determined by the adjacent arrangement in an easier and more stable manner because at least some further measures for determining the relative position in the specified orientations of the spatial directions can be dispensed with. For example, such further measures involve effort and/or create weaknesses in the fastening of the elements to each other.

In particular, at least one of the following is provided in the at least partial determination of the relative position between at least one functional element and the support element by the adjacent arrangement:
that the relative position in at least two spatial directions is determined by the adjacent arrangement in at least one orientation of the relevant spatial direction; and/or
that the relative position in three spatial directions is determined by the adjacent arrangement in at least one orientation of the relevant spatial direction; and/or
that the relative position in at least one spatial direction, in particular in two spatial directions, is determined by the adjacent arrangement in both orientations of the relevant spatial direction.

For example, for cost-effective manufacture and/or a stable design of the vehicle body unit, it is advantageous if the relative position is determined in as many spatial directions and/or in as many orientations of the spatial directions as possible by the adjacent arrangement.

In particular, the relative position between the at least one functional element and the support element is not fixed in all spatial directions in both orientations, because in at least one orientation of a spatial direction the functional element and the support element must be brought into the intended relative position.

Advantageously, the molded-on retaining part holds at least one functional element relative to the support element in at least one orientation of at least one spatial direction.

In particular, the at least one functional element is held by the molded-on retaining part in at least most, preferably in all, of the one or more orientations of the at least one spatial direction in which the relative position between this at least one functional element and the support element is not determined by the adjacent arrangement.

Advantageously, the relative position between the at least one functional element and the support element is thus fixed in a structurally simple way in exactly one orientation of exactly one spatial direction and/or in the plurality of orientations and/or plurality of spatial directions in which the functional element and the support element could still be freely movable despite the adjacent arrangement.

It is particularly advantageous if at least one functional element is adjacently arranged at least partially in a positive-locking manner on the support element.

In particular, the relative position between the functional element and the support element can be determined particularly advantageously by means of the at least partial positive locking.

Advantageously, the at least partial positive locking between the functional element and the retaining part provides additional stabilization of the attachment of the two elements to each other.

The at least partial positive locking can be achieved in a variety of ways.

In advantageous embodiments, at least one functional element, is adjacently arranged in particular with the retaining part thereof on a curvature region of the support element.

In particular, this advantageously achieves at least a partial positive lock between the functional element and the support element.

This advantageously achieves a relative position between the functional element and the support element in a plurality of spatial directions and, for example, in a plurality of orientations of the spatial directions.

In some advantageous embodiments, at least one positive-locking element is provided, wherein the at least one positive-locking element at least forms a positive-locking connection between at least one functional element, which is arranged in contact with the support element, and the support element.

For example, a particularly stable positive connection can be formed using the at least one positive-locking component.

For example, by forming the at least one positive-locking part, the relative position between the at least one functional element and the support element can be determined at least in one orientation of at least one spatial direction in which the relative position is not yet determined by the adjacent arrangement.

In some advantageous embodiments, the at least one functional element has at least one positive-locking part.

In some advantageous embodiments, the support element has at least one positive-locking part.

It is particularly advantageous if at least one positive-locking part of the at least one functional element and at least one positive-locking part of the support element interact in a positive-locking manner.

No further details have yet been provided regarding advantageous designs of the at least one support element.

It is particularly advantageous if at least one of the following is provided:
that the support element has an inner region at least in portions; and/or
that the support element comprises at least one longitudinal portion and preferably a plurality of longitudinal portions, wherein in particular the at least one longitudinal portion and in particular the plurality of longitudinal portions each extend longitudinally, wherein in particular two longitudinal portions are spaced apart from each other transversely to their longitudinal extent, wherein in particular at least two longitudinal portions extend longitudinally at least approximately parallel to each other; and/or
that at least in portions the inner region of the support element is defined between at least two longitudinal portions of the support element; and/or
that at least one further longitudinal portion of the support element connects the two spaced-apart longitudinal portions; and/or
that the support element has at least in portions an open side, wherein in particular on the open side the support element is designed to open the inner region to the outside; and/or
that the support element is a C-profile.

In particular, the support element is designed to extend longitudinally along a component axis with at least one longitudinal portion or preferably with a plurality of longitudinal portions.

Advantageously, a longitudinal portion of the support element is arranged opposite the open side and, in particular, this oppositely arranged longitudinal portion connects two longitudinal portions that are spaced apart from each other.

Advantageously, the support element is at least partially, and in particular at least predominantly, made of a support material, wherein the support material is stiffer and/or stronger than a material of the injection molding element.

In particular, the stiffness, for example the modulus of elasticity and/or the shear modulus, of the support material is greater than, advantageously at least 20% greater than, in particular at least 50% greater than, preferably at least twice as great as, the stiffness of the material of the injection molding element.

In some particularly advantageous embodiments, the stiffness, for example the modulus of elasticity and/or the shear modulus, of the support material is at least 5 times greater, for example at least ten times greater, than the stiffness of the material of the injection molding element.

In particular, the strength of the support material is greater, advantageously at least 20% greater than, preferably at least 50% greater than, for example at least twice as great as, the strength of the material of the injection molding element.

In particular, at least one of the following is provided:
that at the support element is at least partially made of a metallic material; and/or
that the support element is at least partially made of a material comprising a plastics material.

In particular, at least one functional element is arranged in contact with a metallic portion of the support element.

For example, the at least partial formation of the support element from a metallic material and/or from a material comprising a plastic material offers the possibility of designing the support element, for example in portions, according to special requirements.

In particular, the longitudinal portions are at least mostly made of a metallic material.

For example, the support element is at least partially made from an injection molding element.

In some advantageous embodiments, the support element is and in particular at least one longitudinal portion is at least partially, for example at least predominantly, made of a composite material.

Preferably, the composite material of the support element is a fiber composite and/or a plastics composite material.

For example, the support element, and in particular at least one longitudinal portion, is at least partially made of an organic sheet.

In some advantageous embodiments, at least one functional element, in particular with a flange portion thereof, is adjacently arranged in contact with the support element over a large area.

In particular, the large-area adjacent arrangement is advantageous for the stability of the vehicle body unit and in particular for the attachment of the functional element to the support element. For example, acting forces are distributed over the large area, and stress on the connection between the functional element and the support element has a less damaging effect.

In particular, the adjacently arranged portion extends into an expansion area and is arranged adjacent thereto with a side that expands in the expansion area.

In particular, the thickness of the adjacent portion, which is measured at least substantially perpendicular to the expansion surface, is smaller and preferably significantly smaller, for example at least 5 times smaller and in particular at least 10 times smaller, than the extent of the adjacently arranged portion in the expansion area.

In some advantageous embodiments, at least a portion of the expansion area is a flat surface.

In some advantageous embodiments, at least a portion of the expansion area is a curved surface.

In advantageous embodiments, at least one functional element which is arranged in particular in contact with the support element engages at least partially, in particular with the retaining part thereof, in the support element.

In particular, at least one functional element engages, in particular with the retaining part thereof, in the inner region of the support element.

Advantageously, at least one functional element, in particular with the retaining part thereof, is arranged in the inner region in contact with the support element.

In particular, this can ensure a stable design.

Advantageously, a relative position between the engaging functional element and the support element is fixed, in particular by the adjacent arrangement in the interior area in a plurality of spatial directions and preferably in a plurality of directions in which loads occur.

In some advantageous embodiments, at least one functional element extends at least partially between at least two portions, in particular between at least two longitudinal portions, of the support element. Advantageously, the retaining part of the functional element extends at least partially between the two portions, in particular the two longitudinal portions of the support element.

It is particularly advantageous if the functional element, in particular the retaining part thereof, extends at least partially from one of the at least two longitudinal portions to the other of the at least two longitudinal portions.

In particular, this ensures a stable design.

Advantageously, the at least two portions are stabilized in their spaced-apart arrangement by the part of the functional element extending between them. Advantageously, the part of the functional element extending between the at least two portions is held at least by these at least two portions, so that at least a partial fixation of the functional element is achieved.

In advantageous embodiments, at least one functional element, in particular the retaining part thereof, is arranged in contact with at least two longitudinal portions of the support element.

Preferably, at least one of the following is provided:
that at least one functional element is arranged at least partially over a large area in contact with at least two longitudinal portions of the support element; and/or
that at least one functional element, in particular the retaining part thereof, is arranged in contact with the at least two longitudinal portions between which it extends at least partially.

In particular, this ensures a particularly stable design. Advantageously, this adjacent arrangement establishes a relative position of the functional element in a plurality of spatial directions.

In advantageous embodiments, at least one contact surface of the adjacently arranged portion of the at least one functional element contacts at least one contact surface of the support element.

Advantageously, the retaining part forms the contact surface of the functional element.

In particular, the contacting of the contact surfaces of the functional element and the support element achieves a stable arrangement of these relative to each other.

For example, contact between the contact surfaces of the functional element and the support element achieves a structurally simple solution for the adjacent arrangement.

It is particularly advantageous if the retaining part of at least one injection molding element is molded onto at least one side of the retaining part over a large area and advantageously at least substantially completely on that side. Advantageously, at least one side is oriented in a spatial direction in which the relative position between the functional element and the support element is not determined by the adjacent arrangement thereof.

Advantageously, molding on the retaining part over a large area ensures, at least on this side, that the functional element is held stably in the intended relative position also in this orientation of this at least one spatial direction.

It is particularly advantageous if the retaining part of the at least one injection molding element is at least substantially completely molded onto the retaining part and/or onto the adjacently arranged portion of the support element.

In particular, this allows a particularly stable hold by the retaining part.

In some preferred embodiments, the retaining part embeds the retaining part of the at least one functional element at least substantially completely.

In particular, no material of the retaining part is arranged between the mutually facing sides of the adjacently arranged portions of the functional element, in particular the retaining part and the support element, because these portions are arranged in contact with each other.

In particularly advantageous embodiments, the retaining part engages at least the support element and/or at least the at least one functional element, in particular the retaining part of the at least one functional element, at least partially in a positive-locking manner.

In particular, at least one of the following is provided:
that the retaining part at least partially surrounds the support element and/or the at least one functional element, in particular the retaining part, in a positive-locking manner,
wherein, for example, the retaining part at least partially surrounds the support element and/or the at least one functional element on an outer side and/or outer edge thereof in a positive-locking manner; and/or
that the retaining part engages in at least one recess of the support element and/or in at least one recess of the at least one functional element, in particular in at least one recess of the retaining part of the at least one functional element.

For example, at least one recess of the support element and/or of the at least one functional element is a partially formed recess, in particular in the form of a blind hole.

Advantageously, at least one recess of the support element and/or of the at least one functional element is a continuous recess through the element.

Advantageously, the retaining part extends through the continuous-formed component.

In some advantageous embodiments, the retaining part surrounds at least one undercut of the support element and/or at least one undercut of the at least one functional element, in particular an undercut of the retaining part of the at least one functional element.

Advantageously, the at least partially positive-locking gripping of the retaining part results in a particularly stable attachment thereof to the support element and/or the functional element. Advantageously, the retaining part can hold the support element and/or the functional element particularly advantageously in the intended relative position by the at least partial positive engagement thereof.

In particular, the injection molding element is made of a material comprising a plastic material. In particular, the injection molding element is a plastic injection molding element.

Preferably, at least one injection molding element of the vehicle body unit is at least partially fiber-reinforced.

Ideally, at least one molded-on injection molding element and, advantageously, the retaining part thereof are at least partially fiber-reinforced.

In advantageous embodiments, at least one reinforcing component of at least one injection molding element is fiber-reinforced.

For example, at least some fibers used in fiber reinforcement are glass fibers and/or carbon fibers.

In advantageous embodiments, at least one injection molding element forms at least one reinforcing component for the support element and/or for a functional element.

Advantageously, the support element and/or the functional element is reinforced by the reinforcing component.

It is particularly advantageous if at least one injection molding element together with at least one retaining part forms at least one reinforcing component.

The at least one functional element can be made from a wide variety of materials.

In advantageous embodiments, the at least one functional element is formed at least partially and advantageously at least predominantly from a metallic material.

In some advantageous embodiments, at least one functional element is a metallic functional element.

In some advantageous embodiments, at least one functional element, in particular the retaining part thereof, and the support element are connected to each other in addition to the adjacent arrangement and/or in addition to at least partially molding on the injection molding element, in particular additionally by material connection and/or positive locking and/or friction locking.

For example, at least one functional element, in particular the retaining part thereof, and the support element are additionally welded and/or glued and/or soldered together.

For example, at least one functional element, in particular the retaining part thereof, and the support element are additionally connected to each other in a positive-locking manner by reshaping, in particular by clinching, in particular by positive locking.

For example, at least one functional element, in particular the retaining part thereof, and the support element are additionally connected to each other by at least one joining element. For example, they are additionally screwed and/or riveted together.

For example, one advantage of an additional connection is that the functional element and the support element can be held together more stably.

For example, an additional connection can simplify the manufacturing process by allowing the two elements to be at least partially fixed to each other before the injection molding element is at least partially formed.

For example, one advantage of forming the additional connection after at least partial molding of the injection molding element is that the two elements are then calibrated to each other and the additional connection, which in particular increases stability, is produced in the calibrated state.

In some particularly advantageous embodiments, at least one additional connection is produced in the same tool in which the injection molding of the at least one injection molding element also takes place. In particular, this simplifies the manufacturing process by eliminating the need for an additional tool and the steps of inserting into and removing from another tool. Preferably, the calibration of the at least two elements to each other takes place in this same tool, followed by the steps of injection molding the injection molding element and producing the at least one additional connection.

In some advantageous embodiments, at least one functional element, in particular at least the retaining part thereof, and the support element are free from an additional connection, in particular one that transfers at least force and/or stresses, i.e., in particular free from an additional connection to the adjacent arrangement and/or at least partial molding on of the injection molding element, in particular at least free from an additional material-locking and/or positive-locking and/or friction-locking connection.

For example, one advantage of this is that the vehicle body unit can be manufactured in a simpler and/or more cost-effective way. For example, by omitting an additional connection, the manufacturing process can be simplified insofar as an additional manufacturing step, in particular an additional joining step, can be avoided.

The functional element can be designed and configured to fulfill a wide variety of functions.

In advantageous embodiments, at least one functional element is designed as a fastening element. In particular, at least one functional element is designed as a fastening element at least for fastening a vehicle functional unit and/or for fastening a control unit and/or for fastening at least one further vehicle body component.

Advantageously, the functional element designed as a fastening element has at least one fastening part for fastening a unit and/or a component.

In some advantageous embodiments, the vehicle body unit comprises at least one further vehicle body component.

Advantageously, at least one further vehicle body component is attached to the functional element of the vehicle body unit.

In advantageous embodiments, the underlying object mentioned at the outset is achieved by a vehicle body for a vehicle, wherein the vehicle body has at least one vehicle body unit with at least one of the optional features explained above and/or below, and advantageously has a combination of these features.

In advantageous embodiments of the invention, the aforementioned object is achieved by a vehicle, in particular a motor vehicle, wherein the motor vehicle comprises at least one vehicle body unit with at least one of the, for example, optional features explained above and/or below and advantageously a combination of these features and/or wherein the vehicle comprises a vehicle body with at least one such vehicle body unit.

In the above and below, it is to be understood in particular that, for example, deviations of up to ±20%, preferably of up to ±10%, e.g., of up to ±5%, are included, and/or that the feature is at least substantially provided, in the case of features that are at least approximately provided.

Above and below, it is to be understood in particular that, in the case of features that are at least substantially provided, deviations that are technically caused and/or not technically relevant are included, and/or that deviations of up to ±5% are included.

Above and below, the wording that a feature is provided at least for the most part in an entity, e.g., that a feature is provided at least for a large part of elements of a total quantity and/or at least for the most part along a length, is to be understood in particular as meaning that the feature is provided in at least half, preferably at least 70% and in particular at least 80%, e.g., at least 90%, of the entity, i.e., for example, the total number and/or the length, and/or that, for example, the feature is provided at least substantially in the entity, i.e., in particular within technically determined and/or technically irrelevant tolerances.

Above and below, elements and features which are described as, for example and/or in particular and/or preferably and/or expediently and/or in particular in a preferred manner and/or provided in variants and/or the like are optional features which, for example, represent developments of the invention, but are not absolutely necessary for the success of the basic solution according to the invention.

The description of solutions according to the invention thus comprises in particular the various feature combinations defined by the following numbered embodiments:

1. A vehicle body unit (210) comprising at least one support element (212) extending in particular longitudinally, at least one injection molding element (214) and at least one functional element (310), wherein at least one functional element (310), in particular with a retaining part (312), is arranged at least partially in contact with the at least one support element (212) and at least one retaining part (362) of at least one injection molding element (214) is at least partially molded onto the at least one support element (212) and the at least one adjacently arranged functional element (310).

2. The vehicle body unit (210) according to embodiment 1, wherein at least one functional element (310) is arranged in contact with the support element (212), in particular with the retaining part (312) thereof along a force flow path (352) provided in the vehicle body unit (210).

3. The vehicle body unit (210) according to any of the preceding embodiments, wherein the at least partially adjacent arrangement of at least one functional element (310) on the support element (212) defines a relative position between the at least one functional element (310) and the support element (212) in at least one orientation of at least one spatial direction (377, 379, 381),
wherein in particular at least one of the following is provided:
   that the relative position in at least two spatial directions (377, 379, 381) is determined by the adjacent arrangement in at least one orientation of the relevant spatial direction (377, 379, 381); and/or
   that the relative position in three spatial directions (377, 379, 381) is determined by the adjacent arrangement in at least one orientation of the relevant spatial direction (377, 379, 381); and/or
   that the relative position is determined by the adjacent arrangement in at least one spatial direction (377, 379, 381), in particular in two spatial directions (377, 379, 381), in both orientations of the relevant spatial direction (377, 379, 381).

4. The vehicle body unit (210) according to any of the preceding embodiments, wherein at least one functional element (310) is held relative to the support element (212) in at least one orientation in at least one spatial direction (377, 379, 381) by the molded retaining part (362),
and that, in particular, the at least one functional element (310) is held by the molded retaining part (362) in at least most, in particular all, of the one or more orientations of the at least one spatial direction (377, 379, 381) in which the relative position between this at least one functional element (310) and the support element (212) is not determined by the adjacent arrangement.

5. The vehicle body unit (210) according to any of the preceding embodiments, wherein at least one functional element (310) is arranged at least partially in a positive-locking manner in contact with the support element (212).

6. The vehicle body unit (210) according to any of the preceding embodiments, wherein at least one functional element (310) is arranged in particular with the retaining part (312) thereof in contact with a curvature region (242) of the support element (212).

7. The vehicle body unit (210) according to any of the preceding embodiments, wherein at least one positive-locking part (392, 394) forms a positive lock between at least one functional element (310), arranged in contact with the support element (212), and the support element (212).

8. The vehicle body unit (210) according to any of the preceding embodiments, wherein at least one of the following is provided:
that the support element (212) has at least a portion of an inner region (244); and/or
that the support element (212) comprises a plurality of longitudinal portions (222, 224, 226), wherein in particular the longitudinal portions (222, 224, 226) extend longitudinally, wherein in particular two longitudinal portions (222, 224, 226) are spaced apart from each other transversely to their longitudinal extent,
wherein in particular at least two longitudinal portions (222, 224, 226) extend longitudinally at least approximately parallel to each other; and/or
that at least in portions the inner region (244) of the support element (212) is defined between at least two longitudinal portions (222, 224, 226) of the support element (212); and/or
that at least one further longitudinal portion (222, 224, 226) of the support element (212) connects the two spaced-apart longitudinal portions together; and/or
that the support element (212) has at least in portions an open side (252), wherein in particular the inner region (244) is open to the outside on the open side (252); and/or
that the support element (212) is a C-profile.

9. The vehicle body unit (210) according to any of the preceding embodiments, wherein at least one of the following is provided:
that the support element (212) is at least partially made of a metallic material; and/or
that the support element (212) is at least partially made of a material comprising a plastics material.

10. The vehicle body unit (210) according to any of the preceding embodiments, wherein at least one functional element (310) is arranged in particular with a flange section (322) in contact over a large area with the support element (212).

11. The vehicle body unit (210) according to any of the preceding embodiments, wherein at least one functional element (310) engages at least partially, in particular with the retaining part (312) thereof, in the support element (212), in particular in the inner region (244) of the support element (212).

12. The vehicle body unit (210) according to any of the preceding embodiments, wherein at least one functional element (310) extends at least partially, in particular with the retaining part (312) thereof, between at least two portions, in particular between at least two longitudinal portions (222, 224, 226), of the support element (212).

13. The vehicle body unit (210) according to any of the preceding embodiments, wherein at least one functional element (310), in particular with the retaining part (312) thereof, is arranged in contact with at least two longitudinal portions (222, 224, 226) of the support element (212).

14. The vehicle body unit (210) according to any of the preceding embodiments, wherein at least one contact surface (332) of the adjacently arranged portion of the at least one functional element (310) contacts at least one contact surface (334) of the support element (212).

15. The vehicle body unit (210) according to any of the preceding embodiments, wherein the retaining part (362) of the at least one injection molding element (214) is at least substantially completely formed at least on the retaining part (312) and/or the adjacently arranged portion of the support element (212).

16. The vehicle body unit (210) according to any of the preceding embodiments, wherein the retaining part (362) embeds the retaining part (312) of the at least one functional element (310) at least substantially completely.

17. The vehicle body unit (210) according to any of the preceding embodiments, wherein the retaining part (362) engages at least the support element (212) and/or at least the at least one functional element (310), in particular the retaining part (312) of the at least one functional element (310), at least partially in a positive-locking manner.

18. The vehicle body unit (210) according to any of the preceding embodiments, wherein at least one of the following is provided:
that the retaining part (362) at least partially surrounds the support element (212) and/or the at least one functional element (310) in a positive-locking manner; and/or
that the retaining part (362) engages in at least one recess (366, 368) of the support element (212) and/or in at least one recess (366, 368) of the at least one functional element (310).

19. The vehicle body unit (210) according to any of the preceding embodiments, wherein at least one injection molding element (214), in particular the molded injection molding element (214), in particular the retaining part (362), is at least partially fiber-reinforced.

20. The vehicle body unit (210) according to any of the preceding embodiments, wherein at least one injection molding element (214) forms at least one reinforcing component for the support element (212) and/or for a functional element (310).

21. The vehicle body unit (210) according to any of the preceding embodiments, wherein at least one functional element (310) is at least partially made of a metallic material and in particular is a metallic functional element (310).

22. The vehicle body unit (210) according to any of the preceding embodiments, wherein at least one functional element (310) is designed as a fastening element, in particular as a fastening element at least for fastening a vehicle functional unit and/or for fastening a control unit and/or for fastening at least one further vehicle body component.

23. The vehicle body unit (210) according to any of the preceding embodiments, wherein the vehicle body unit (210) comprises at least one further vehicle body component, and wherein the at least one further vehicle body component is attached to the functional element (310).

24. A vehicle body (110) for a vehicle, wherein the vehicle body (110) comprises at least one vehicle body unit (210) according to any of the preceding embodiments.

25. A vehicle, in particular a motor vehicle, comprising at least one vehicle body unit (210) according to any of the preceding embodiments and/or comprising a vehicle body (110) according to the preceding embodiment.

Preferred embodiments and features of the invention and, for example,
advantages thereof are the subject of the following detailed description and the illustrated representation of a plurality of exemplary embodiments in different variants.

### BRIEF DESCRIPTION OF THE DRAWINGS

In the drawings:

FIG. 1 shows the vehicle body of a vehicle;

FIG. 2 shows a first exemplary embodiment of a vehicle body unit comprising at least one support element, one functional element and one injection molding element at least partially molded onto these elements;

FIG. 3 shows an enlarged detail view of the vehicle body unit of the first

exemplary embodiment in a region in which the functional element is arranged in contact with the support element;

FIG. 4 shows the region of the vehicle body unit shown in FIG. 3 without the molded injection molding element;

FIG. 5 shows a sectional view according to section V-V shown in FIG. 2;

FIG. 6 shows an enlarged detail view of a vehicle body unit of a second exemplary embodiment in a region in which a functional element is arranged in contact with a support element and an injection molding element is at least partially molded onto these elements;

FIG. 7 shows a representation of the region of the vehicle body unit shown in FIG. 6 without the molded-on injection molding element;

FIG. 8 shows a sectional view according to section VIII-VIII shown in FIG. 6;

FIG. 9 shows an enlarged detail view of a vehicle body unit of a third exemplary embodiment in a region in which a plurality of functional elements is arranged in contact with a support element and an injection molding element is at least partially molded onto these elements;

FIG. 10 shows the region of the vehicle body unit depicted in FIG. 9 with only some of the plurality of functional elements and without the molded injection molding element; and

FIG. 11 shows a perspective view of a functional element of the third exemplary embodiment.

### DETAILED DESCRIPTION OF THE INVENTION

An exemplary embodiment of a vehicle body of a motor vehicle, designated in its entirety by 110 and not shown in detail in the drawings, comprises a plurality of vehicle body components, which are in particular bracing parts for the vehicle body frame and formwork parts and, for example, attachment parts.

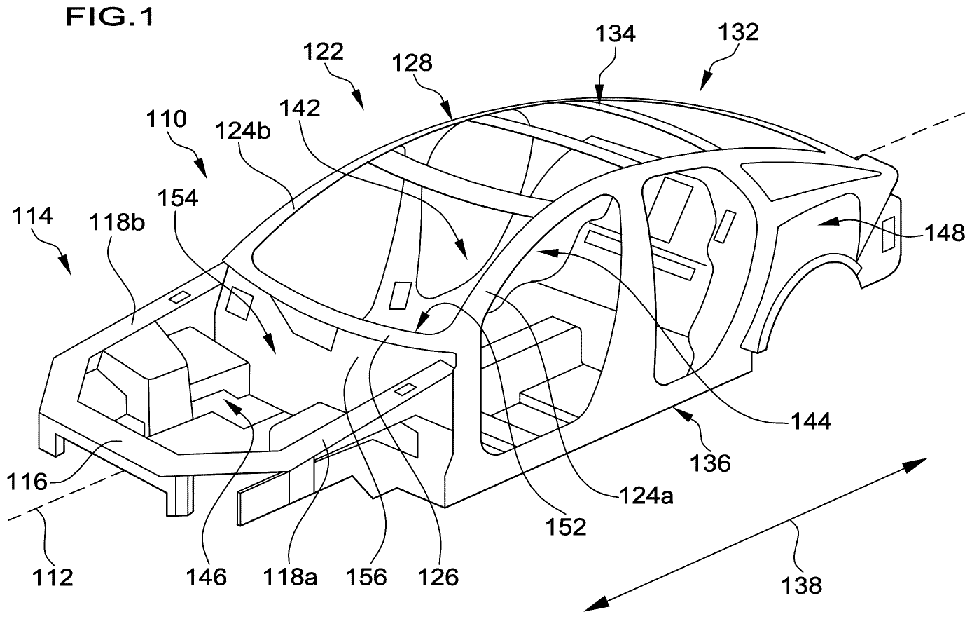

The vehicle body 110 is shown at least partially in FIG. 1 by way of example.

The vehicle body comprises, in particular in a forward region 114 relative to a vehicle longitudinal axis 112, a forward cross member 116, on which two longitudinal members 118a and 118b are arranged laterally and extend to a central region 122 and are connected to a corresponding A-pillar support 124a and 124b.

Preferably, in the central region 122, with reference to the vehicle longitudinal axis 112 at the front, a windshield cross member 126, which extends transversely to the vehicle longitudinal axis 112, and in an upper region a roof support structure 128, which comprises in particular cross members and longitudinal members and extends above the central region 122, are provided. The A-pillar supports 124a and 124b are arranged laterally in the central region and are connected to the windshield cross member 126 and the roof support structure 128.

In a back rear region 132, a rear support structure 134, which also includes cross members and longitudinal members, is arranged and is connected to the roof support structure 128.

In particular, the vehicle body 110 also comprises a vehicle body substructure 136, which is arranged below the roof support structure 128 and is connected directly or indirectly to the longitudinal members 118, the column supports 124a, b and the rear support structure 134 by means of support elements.

An oriented vehicle longitudinal direction 138 is oriented along the vehicle longitudinal axis 112 from the rear region 132 forward to the forward region 114, so that with respect to the vehicle longitudinal direction 138 the forward region 114 is at the front and the rear region 132 is at the rear. In particular, the vehicle's longitudinal direction 138 substantially corresponds to the vehicle's direction of travel when driving straight ahead.

The preceding and following formulations above and below refer to a proper alignment of the vehicle body and the vehicle, in particular when it is on a horizontal surface with respect to a vertical through the vehicle's longitudinal axis 112, so that the roof support structure 128 is arranged at the top and the vehicle body substructure 136 is arranged at the bottom of the vehicle body, and, in the case of the vehicle on the horizontal surface, the roadway is below the vehicle body substructure 136.

The vehicle body 110 defines an interior 142 in which the passenger compartment is provided in the central region 122 and, in particular, an engine compartment 146 is arranged in the forward region 114 and a trunk 148 of the vehicle is arranged in the rear region 132, provided that the vehicle has front-wheel drive and in variants in which the vehicle has rear-wheel drive, an engine compartment is arranged in the rear region 132 and, for example, a trunk 148 is arranged in the forward region 114.

In particular, the interior 142 comprises a cockpit region 152 and a front region 154, which is located in front of the cockpit region 152 with respect to the vehicle longitudinal axis 112 and with respect to the vehicle longitudinal direction 138. In particular, the cockpit region 152 is at least a sub-region of the passenger compartment 144. For example, the front region 154 is at least a part of the engine compartment 146 in the front-wheel drive vehicle, or in variants of the rear-wheel drive vehicle, for example, a part of the trunk.

In particular, the cockpit region 152, and preferably the entire passenger compartment, is arranged between the roof support structure 128 and the vehicle body substructure 136 with respect to one direction, in particular the vertical direction.

In particular, the windshield cross member 126 is arranged in front of the cockpit region with respect to the vehicle's longitudinal direction 138.

Preferably the vehicle body 110 comprises an end face 156, which is arranged between the cockpit region 152 and the front region 154. In particular, the end face 156 is attached to the longitudinal members 118a, b, the A-pillar members 124a, b and the vehicle body substructure 136.

In particular, the interior 142 extends in an at least substantially vertical direction between the roof support structure 128 and the vehicle body substructure 136 and, with respect to the vehicle longitudinal direction 138, between the forward cross member 116 and a rear region of the rear support structure 134.

An exemplary embodiment of a vehicle body unit 210 comprising a plurality of components comprises an advantageously longitudinally extending support element 212 and at least one injection molding element 214 which is molded onto the support element 212.

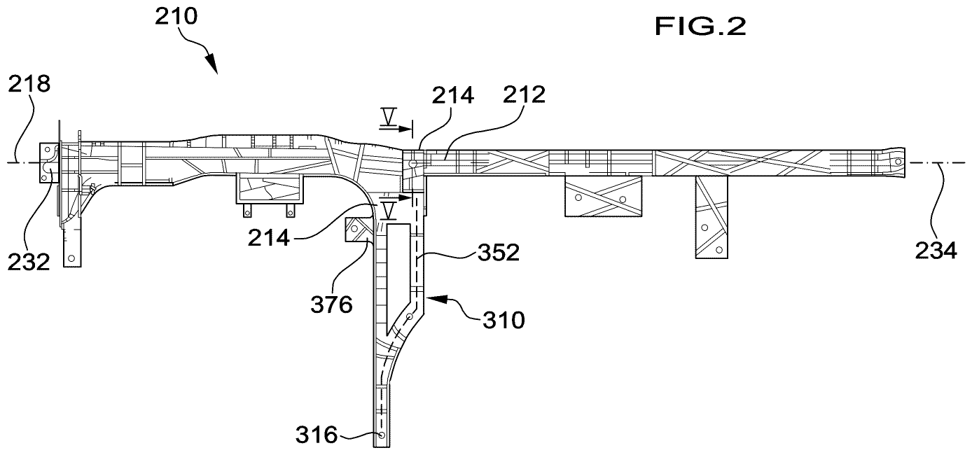

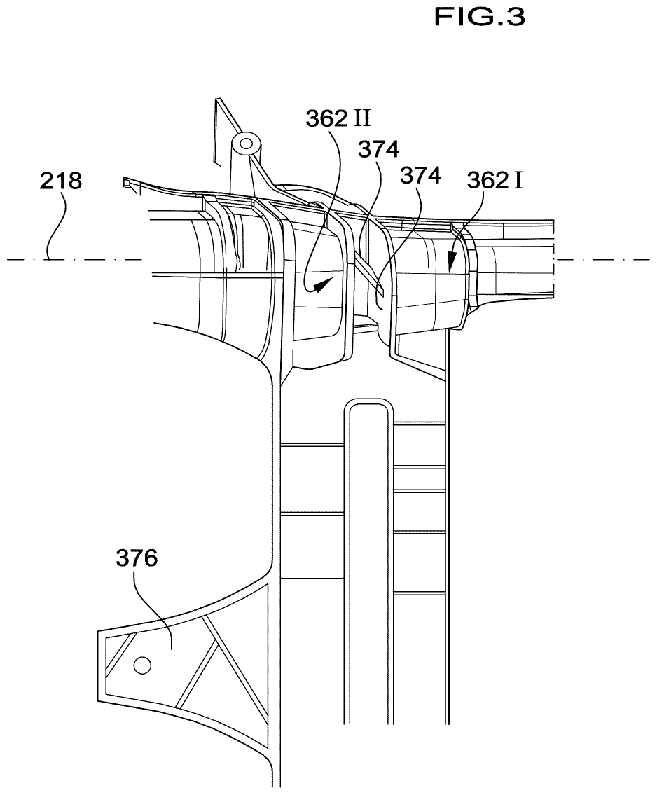

An exemplary embodiment of a vehicle body unit 210 in one variant is shown in FIG. 2 to 5.

In particular, the support element 212 extends between the A-pillar supports 124a, b and is attached to these as well as indirectly via vehicle body components, for example vehicle body components of the vehicle body unit 210, to the vehicle body substructure 136.

In particular, the vehicle body unit 210 is designed at least for the attachment of vehicle functional units, for example a steering column, and for example at least for the attachment of control units by means of which a driver of the vehicle can control the vehicle and, for example, units of its equipment, for example an air conditioning system and/or an audio system and/or a navigation system. For example, the vehicle body unit 210 includes at least elements of such units.

In variants of the exemplary embodiment, the vehicle body unit 210 may also have additional and/or alternative functions and/or be arranged in a different region of the vehicle body and attached to other vehicle body components.

In particular, the support element 212 defines a component axis 218 along which the support element 212 extends with a longitudinal extent.

In particular, individual components of the vehicle body unit 210, for example components of an injection molding element 214 and/or of a functional element, extend transversely to the component axis 218 from the support element 212.

For example, the support element 212 is a metallic support element.

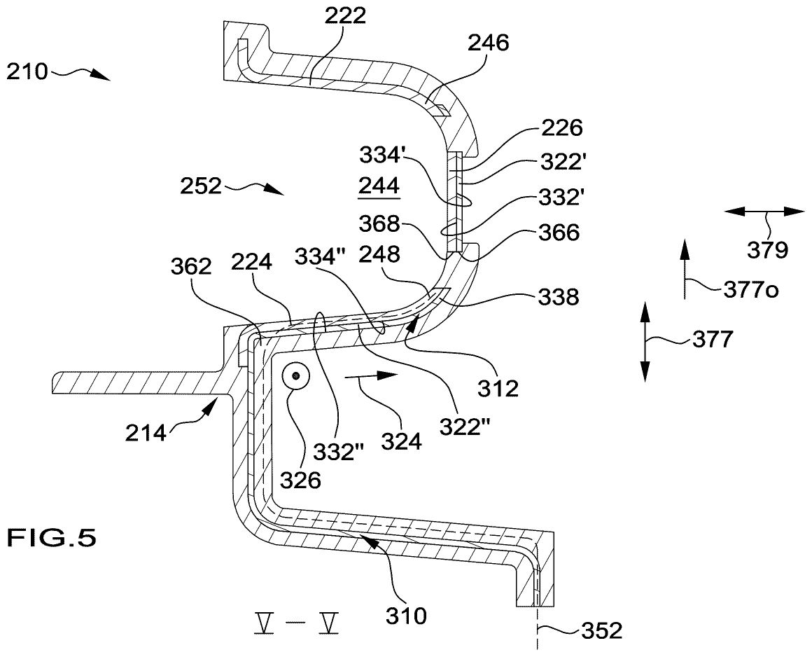

Preferably, the support element 212 has an open cross-sectional profile, in particular a C-profile transverse to the longitudinal extent thereof, in particular with respect to a cross section which is at least approximately perpendicular to the component axis 218, as is shown by way of example in FIG. 5.

Advantageously, the support element 212 comprises a plurality of longitudinal portions 222, 224, 226, which extend at least for the most part along the component axis 218 between two longitudinal ends 232 and 234 of the support element 212 that are opposite each other along the component axis 218.

Preferably, the longitudinal portions 222, 224, 226 are long, narrow and thin longitudinal portions. In particular, the length of a relevant longitudinal portion 222, 224, 226, measured in particular in the axial direction of the component axis 218, is longer, in particular significantly longer, than the width of the relevant longitudinal portion measured transversely to the longitudinal extent. In particular, the thickness of a relevant longitudinal portion 222, 224, 226, which is measured at least approximately perpendicular to the directions in which the length and width of the relevant longitudinal portion 222, 224, 226 are measured, is smaller, advantageously significantly smaller, than the length and/or width of the relevant longitudinal portion 222, 224, 226. In particular, in this context, an extension is substantially larger or smaller than another extension if the substantially larger or smaller extension is at least 5 times larger or smaller, and in particular at least 10 times larger or smaller, than the other extension.

In particular, the longitudinal portions 222, 224, 226 run at least in portions along the component axis 218 in a largely straight line.

Advantageously, at least one of the longitudinal portions 222, 224, 226 has at least one curvature region 242.

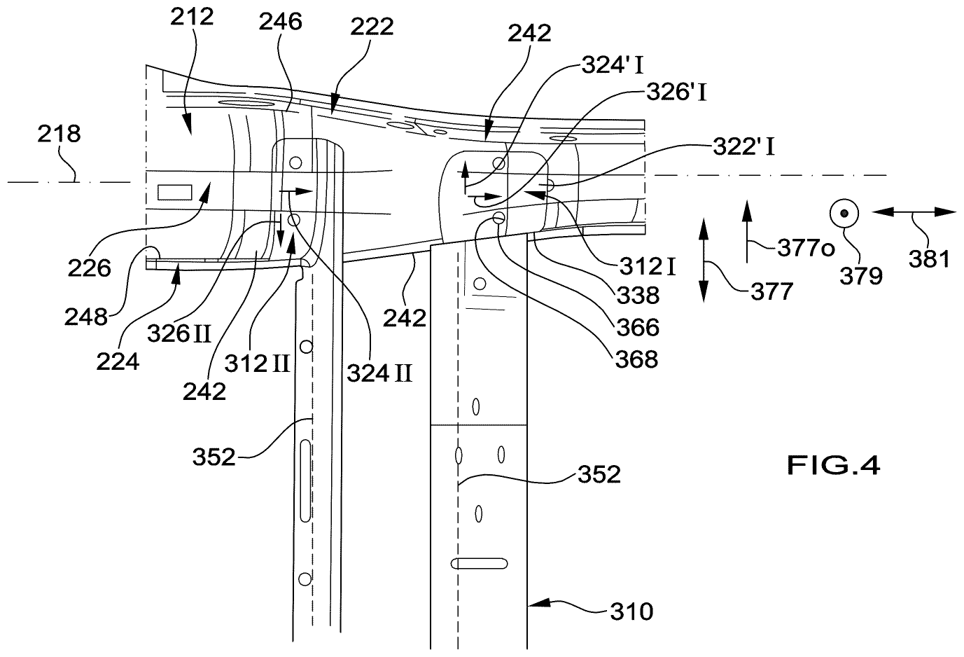

In particular, at least one longitudinal portion 222, 224, 226 is curved along the longitudinal extent thereof in at least one curvature region 242, as is shown by way of example in FIG. 4 for the longitudinal portions 222 and 224.

Advantageously, two longitudinal portions, for example the longitudinal portions 222 and 224 here, run at least in portions and preferably at least mostly parallel to each other and are spaced apart from each other transversely to the axial direction of the component axis 218. Advantageously, the corresponding inner flat sides of the two longitudinal portions 222, 224 face each other and at least partially define a hollow inner region 244 of the support element 212.

Advantageously, another longitudinal portion, for example in this case the longitudinal portion 226, connects the two longitudinal portions 222, 224, which are spaced apart from each other. In particular, the further longitudinal portion 226 is molded onto each of the two spaced-apart longitudinal portions 222, 224 in a relevant connection region 246, 248. In particular, the further longitudinal portion 226 limits the inner region 244 transversely to the component axis 218 and transversely to the direction in which the two spaced-apart longitudinal portions 222, 224 limit the inner region 244.

Advantageously, the inner region 244 is open toward one side 252 of the support element 212. In particular, the open side 252 is located opposite the further, connecting longitudinal portion 226. In particular, the opening region on the open side 252 is limited by the two spaced apart longitudinal portions 222, 224.

For example, at least one injection molding element 214 includes a reinforcing component with which the support element 212 is reinforced. For example, the reinforcing component has reinforcing ribs. For example, the reinforcing component is at least partially fiber-reinforced.

With regard to advantageous embodiments of an injection molding element 214 with a reinforcing component, reference is made to DE 10 2020 120 452 A1 as a whole and in particular to the descriptions therein of the preferably one-piece injection molding part 214 with a reinforcing component 272. Advantageously, at least one injection molding element 214 with the reinforcing component thereof is directly injection molded onto the support element 212.

The vehicle body unit 210 comprises at least one functional element 310, for example exactly one functional element 310 or preferably a plurality of functional elements 310.

A functional element 310 is specifically designed and/or intended for fastening a functional unit and/or a control unit and is, for example, an element of a functional unit and/or control unit.

This document describes exemplary embodiments in different variants of functional elements 310, with further embodiments providing combinations of features of these exemplary embodiments and variants.

In one exemplary embodiment, which is shown by way of example in a variant in FIG. 2 to 5, a functional element 310 comprises at least one retaining part 312, for example two retaining parts 312I and 312II, and the functional element 310 is arranged with the at least one retaining part 312 in contact with the support element 212.

In this exemplary embodiment, in particular, the functional element 310 is a fastening element and is designed, for example, as a longitudinally extending fastening strut.

In particular, the functional element 310 designed as a fastening element comprises at least one fastening part 316 for fastening a functional unit and/or for fastening a control unit and/or for fastening to another vehicle body component.

In particular, the fastening strut at one end, which in the longitudinal extent of the fastening strut is opposite the end with the at least one retaining part 312, comprises a fastening part 316 for fastening to a further vehicle body component, for example for fastening to the vehicle body substructure 136.

In some advantageous variants, the mounting strut includes at least one mounting element along the longitudinal extension thereof for attaching a functional unit and/or a control unit.

Advantageously, the functional element 310, designed as a fastening element, is at least partially, preferably at least predominantly, made of a metallic material.

In particular, the retaining part 312 comprises at least one flange portion 322 which extends over a large area in an expansion area. The expansion area is spanned by two expansion directions 324, 326 that run transversely to each other. The thickness of the flange portion 322, which is measured at least approximately perpendicular to the expansion area, is smaller, preferably significantly smaller, than the expansion of the flange portion 322 in the expansion directions 324, 326.

Advantageously, the expansion area is at least partially flat.

Preferably, the expansion area is at least partially curved. In particular, along an extension of a curved sub-surface of the expansion area, the orientation of at least one of the extension directions 324, 326 changes.

In particular, the flange portion 322 has a contact surface 332 with which the flange portion 322 contacts a contact surface 334 of the support element 212, in particular a contact surface 334 of at least one of the longitudinal portions 222, 224, 226.

In advantageous variants, the contact surface 332 of the flange portion 322 and/or the contact surface 334 of the support element 212 is coated.

In some advantageous variants, the contact surface 332 of the flange portion 322 and/or the contact surface of the support element 334 is uncoated.

In advantageous variants, at least one retaining part 312, here for example the retaining part 312I, forms two flange portions 322′and 322″, wherein one of the at least two flange portions 322 is in contact with one of the longitudinal portions 222, 224, 226 of the support element 212 and the other flange portion 322 of the at least two flange portions 322 is in contact with another of the longitudinal portions 222, 224, 226 of the support element 212. In particular, the at least two flange portions 322 are molded onto each other in a forming region 338 and, advantageously, the forming region 338 is in contact with the connection region 248, which connects the two longitudinal portions 222, 224, 226.

In advantageous variants, at least one retaining part 312 is in contact with a curvature region 242 of the support element 212. Advantageously, the retaining part 312 is curved in the region in contact with the curvature region 242 in a way corresponding to the curvature region.

In some advantageous variants, at least one retaining part 312, here for example the retaining part 312I, is in contact with a curvature region 242, wherein in this curvature region 242 the support element 212, in particular one of the longitudinal portions 222, 224, 226 thereof, is curved along the extent thereof in the axial direction to the component axis 218.

In some advantageous variants, at least one retaining part 312, here for example the retaining part 312II, is in contact with a curvature region 242, wherein in this curvature region 242 the support element 212 is curved transversely to the component axis 218. For example, in this curvature region 242 a longitudinal portion 222, 224, 226 is curved transversely to the component axis 218 and/or the curvature region 242, with the curvature transverse to the component axis 218, is formed in a connection region 248 between two longitudinal portions 222, 224, 226.

In this variant, in particular, the functional element 310, designed as a fastening element, supports the support element 212 in the vertical direction of the vehicle body. In particular, a force flow path 352 is provided from the support element 212 downward via the functional element 310, for example to the vehicle body substructure 136.

Advantageously, the retaining part 312, preferably with a flange portion 122, is arranged along the force flow path 352 in contact with the support element 212.

Advantageously, one contact side of the retaining part 312 runs perpendicular to the direction of the force flow path 352. In particular, the portions of the retaining part 312 and the support element 212 which are arranged in contact with each other are oriented toward each other in one direction, with a force acting in this direction along the force flow path 352.

Thus, in this exemplary embodiment, the retaining part 312 advantageously is at least in portions in contact with a downwardly directed portion of the support element 212.

In particular, in a flange portion 322 which is arranged along a provided force flow path 352 in contact with a support element 212, the expansion directions 324, 326 run transversely and advantageously at least approximately perpendicular to the direction of the force flow path 352.

A retaining part 362 of an injection molding element 214 is at least molded onto and holds the adjacently arranged portions of the retaining part 312 and the support element 212.

Advantageously, at least the adjacent portions of the retaining part 312 and/or the support element 212 are embedded in the retaining part 362 of the injection molding element 214.

In particular, the retaining part 362 is injection molded at least onto the adjacent portions of the retaining part 312 and the support element 212.

In particular, there is no material of the retaining part 362 between the facing sides of the adjacently arranged portions of the retaining part 312 and the support element 212, because these portions are arranged in contact with each other.

Preferably, the retaining part 362 is at least substantially molded onto the entire retaining part 312. Advantageously, the retaining part 312 is embedded in the retaining part 362.

Advantageously, the functional element 310, in particular the retaining part 312 thereof, has at least one recess 366. Advantageously, the support element 212 preferably has at least one recess 368 in the adjacently arranged portion. Advantageously, the injection molding element 214, in particular the retaining part 362 thereof, engages in at least one recess 366 of the functional element 310 and/or in at least one recess 368 of the support element 212.

In some advantageous variants, at least one recess 366, 368 of the functional element 310 and/or the support element 212 is a recess on the element 310, 212, wherein the injection molding element 214 engages in this recess.

In some advantageous embodiments, at least one recess 366 of the functional element 310 and/or at least one recess 368 of the support element 212 is a continuous recess through the element 310, 212 and the injection molding element 214 advantageously extends through this continuous recess 366, 368.

It is particularly advantageous if at least one recess 366 of the functional element 310 and at least one recess 368 of the support element 212 are arranged in alignment with each other, wherein advantageously at least one of the aligned recesses 366, 368 is a continuous recess 366, 368. Advantageously, the injection molding element 214 engages with an identical portion into the two aligned recesses 366, 368 of the functional element 310 and the support element 212, and preferably the injection molding element 214 engages with an identical portion through at least one of the two aligned recesses 366, 368 of the functional element 310 and the support element 212.

Preferably, the injection molding element 214 which has the retaining part 362 is also formed on at least the portions of the functional element 310 and/or the support element 212 that border the adjacent portions.

For example, the injection molding element 214, which comprises the retaining part 362, has at least one reinforcing part 374, for example reinforcing ribs.

For example, the injection molding element 214 which forms the retaining part 362 is also molded onto the functional element 310 at least in portions away from the adjacently arranged portion. In particular, this injection molding element 214 at least in portions forms a reinforcing component for the support element 212.

Advantageously, the injection molding element 214 which forms the retaining part 362 is also molded onto the functional element 310 at least in portions away from the retaining part 212. In particular, this injection molding element 214 at least in portions forms a reinforcing component for the functional element 310.

In some advantageous variants, the injection molding element 214 which forms the retaining part 362 also forms at least one fastening part 376, for example for fastening a functional unit and/or a control unit and/or another vehicle body component.

In advantageous variants, at least one injection molding element 214, in particular the injection molding element 214 which forms the retaining part 362, is at least in portions fiber-reinforced.

Preferably, at least one retaining part 362 and/or one reinforcing component is designed to be at least in portions fiber-reinforced.

In some advantageous variants, the fiber reinforcement is formed by fibers embedded in the injection molding element 214.

For example, a plurality of layers of fibers is provided.

For example, at least some of the fibers in the fiber reinforcement are oriented unidirectionally.

For example, at least some of the fibers of the fiber reinforcement are intertwined; for example, the intertwined fibers form a woven fabric and/or a knitted fabric and/or a braid.

In particular, in a method for manufacturing at least one vehicle body unit 210 and, for example, for manufacturing a vehicle body, at least one molding tool is used for forming at least one injection molding element 214, in particular for forming the injection molding element 214 with the retaining part 362.

The molding tool comprises at least two molding units, each with at least one mold recess. At least in one shaping position of the molding units, the mold recesses form a shaping cavity for an injection molding element 214 to be formed.

Advantageously, in this method the support element 212 is at least partially inserted into a mold recess as an insert, and at least one functional element 310 is arranged as at least one further insert in the mold recess at least with the retaining part 312 thereof in contact with the support element 212. Then the molding units are moved into their forming position and the forming cavity is filled with the material forming the injection molding element 214, in particular a material comprising a plastic material, so that the injection molding element 214 to be formed is molded at least partially onto the support element 212 and at least in portions onto the retaining part 312 of the functional element 310.

In particular, the design and advantages of the vehicle body unit 210, for example, are briefly summarized as follows:
At least one functional element 310 is arranged, in particular, with the retaining part 312 thereof in contact with the support element 212.

Advantageously, this adjacent arrangement establishes a relative position between the functional element 310 and the support element 212, at least in one orientation and at least one spatial direction 377, 379.

Advantageously, the functional element 310 is arranged in contact with a plurality of portions of the support element 212 and/or in contact with at least one curvature region 242.

Advantageously, the relative position between the functional element 310 and the support element 212 is determined by the contact thereof with a plurality of portions of the support element 212, particularly those oriented in different directions, and/or by the arrangement thereof in contact with a curvature region 242 of the support element 212 in a plurality of spatial directions 377, 379, 381, each in at least one orientation of the relevant spatial directions 377, 379, 381.

For example, in this exemplary embodiment, the relative position of the functional element 310 relative to the support element 212 in the vertical spatial direction 377 is determined by the functional element 310 in contact with at least one downwardly oriented portion of the support element 212 in the upwardly oriented vertical spatial direction 377o. Furthermore, the relative position between the functional element 310 and the support element 212 is determined by the functional element 310 being in contact with a vertical portion of the support element 212 in a spatial direction 379 oriented along the longitudinal direction 138 of the vehicle in at least one orientation.

In particularly advantageous variants, the functional element 310 is in contact in a curvature region 242 of the support element 212, wherein in this curvature region 242 a longitudinal portion 222, 224, 226 of the support element 212 is curved in the longitudinal extension thereof along the component axis 218. In particular, the relative position between the functional element 310 and the support element 212 is thus also determined in at least one orientation of a spatial direction 381 oriented along the axial direction of the component axis 218 by the arrangement in contact with this curvature region 242.

In particular, the component axis 218 is oriented transversely and, for example, at least approximately perpendicularly to the vehicle longitudinal axis 112 and the vertical direction of the vehicle body 110. At least in advantageous variants of this exemplary embodiment, the relative position between the functional element 310 and the support element 212 is fixed in up to three spatial directions 377, 379, 381, which are at least substantially perpendicular to each other, at least in one orientation.

In particular, it is advantageous that the functional element 310, in particular with the retaining part 312 thereof, is arranged partially in a positive-locking manner in contact with the support element 212.

For example, this simplifies the assembly of the vehicle body unit 210 because the advantageously positive-locking contact of the functional element 210 with the support element 212 already determines at least partially the relative position between these elements 310, 212.

This advantageously reduces the risk of unwanted slippage of the functional element 210 relative to the support element 212 and preferably prevents such unwanted slippage.

Advantageously, by arranging the functional element 310 in contact with the support element 212, the formation of the vehicle body unit 210 becomes more stable because the functional element 310 is held relative to the support element 212 by the preferably positive-locking contact at least partially in an intended relative position between these elements 310, 212.

Particularly advantageous is the adjacent arrangement of the functional element 310, in particular with the retaining part 312 thereof, on the support element 212 along a provided force flow path 352, and in particular such that the adjacently arranged portions of the functional element 310 and the support element 212 are oriented toward each other in a direction in which a force acts along the force flow path 352.

Advantageously, the force is thus transferred from one of the elements 310, 212 to the other of these elements 212, 310 via the adjacently arranged portions of the functional element 310 and the support element 212. Advantageously, this results in an efficient transmission of force. Advantageously, this reduces the risk of breakage along the force flow path 352, particularly at a transition from one element to another, or in particular avoids such breakage at least substantially.

The retaining part 362 of the injection molding element 214 which is at least partially molded onto the functional element 310, in particular onto the retaining part 312 thereof, and onto the support element 212 holds the functional element 310 and the support element 212 together and in particular determines their relative position also with regard to the orientations and/or spatial directions in which the relative position is not yet determined by the adjacent arrangement.

Advantageously, this allows the relative position between the functional element 310 and the support element 212 to be determined in a constructively simple manner in all orientations of all spatial directions 377, 379, 381.

Advantageously, the relative position between the functional element 310 and the support element 212 in spatial directions 377, 379, 381 and/or the orientations thereof, in which a high stress occurs, is determined by the adjacent arrangement, so that the retaining part 362 only has to hold the functional element 310 relative to the support element 212 in the intended relative position with respect to less stressed directions.

Advantageously, the injection molding element 214, in particular the retaining part 362 thereof, engages in at least one recess 366 of the functional element 310, for example in a recess 366 of the retaining part 312, and/or in a recess 368 of the support element 212. In particular, this improves, and in particular strengthens, the connection between the injection molding element 214 and the functional element 310 and/or the support element 212.

Particularly stable holding by the injection molding element 214, in particular by the retaining part 362 thereof, is achieved by said retaining part reaching through a continuous recess 366, 368 in the functional element 310 and/or the support element 212.

In particular, the functional element 310 and the support element 212 are held particularly stably in their intended relative position when the injection molding element 214, in particular the retaining part 362 thereof, engages in mutually aligned recesses 366, 368 of the functional element 310 and the support element 212 and, for example, extends through at least one of the aligned recesses 366, 368.

Advantageously, the injection molding element 214, in particular the retaining part 362 thereof, has at least one reinforcing part 374, for example a reinforcing rib, so that the formation thereof becomes more stable.

Preferably, the injection molding element 214 which forms the retaining part 362 also has at least one reinforcing component for the support element 212 and/or at least one reinforcing component for the functional element 110 and/or at least one fastening part 376. For example, this results in a more stable formation because a plurality of components and/or parts is formed by one injection molding element 214. For example, this makes the production of the vehicle body unit 110 simple because a plurality of components and/or parts is formed by injecting an injection molding element 214.

In further exemplary embodiments, those elements and features which are at least basically identical and/or at least substantially perform an at least fundamental identical function are assigned the same reference numeral. In particular, if special reference is to be made to a specific design in an exemplary embodiment, a letter designating the corresponding exemplary embodiment is added to the corresponding reference numeral. If elements, parts and/or features are not explained or not explained in detail in an exemplary embodiment, they are preferably designed at least partially as in another exemplary embodiment, so that full reference is made to the explanations in connection with the other exemplary embodiments.

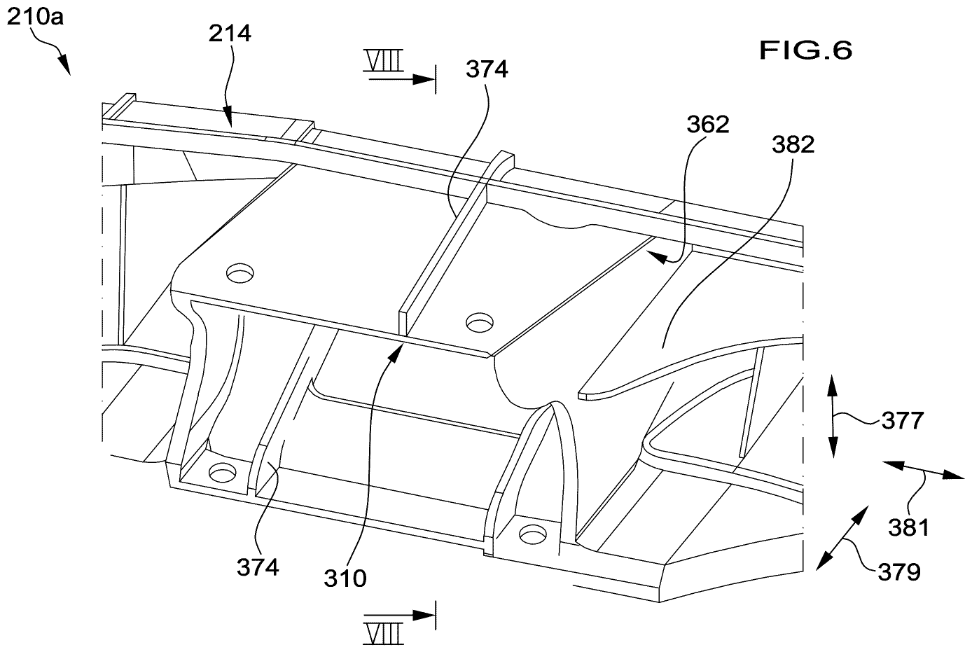

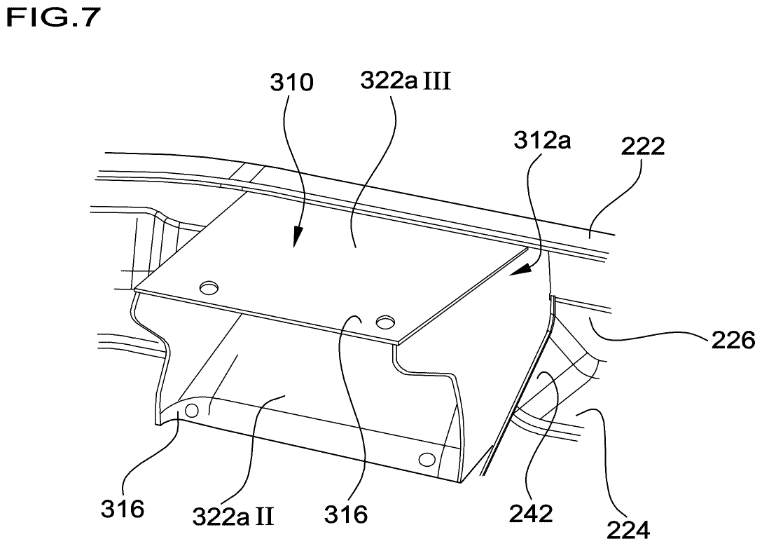

A variant of a second exemplary embodiment is shown by way of example in FIG. 6 to 8.

In particular, in one exemplary embodiment of a vehicle body unit 210a for a vehicle body 110, at least one retaining part 312a of a functional element 310 is designed in a box-like form.

In particular, the retaining part 312a comprises wall portions which form the box-like structure. In particular, the wall portions are thin and extend over a large area, and are therefore flange-like. Therefore, in this sense, the wall portions of the retaining part 312a are also flange portions 322aI, II, III in this exemplary embodiment.

Advantageously, the functional element 310 with the retaining part 312a thereof engages in the inner region 244 at the open side 252 of the support element 212, and at least some of the flange portions 322a are arranged in contact with the support element 212 on the inside, in particular with longitudinal portions 222, 224, 226 of the support element 212.

In particular, in variants of other exemplary embodiments a retaining part 312 of a functional element 310 engages in the inner region 244 of the support element 212, wherein in these other exemplary embodiments the retaining part 312 is not box-shaped. At least with regard to the design reaching into the inner region 244, the description and partly the graphic representation of this second exemplary embodiment is also representative for these other exemplary embodiments.

In particular, a flange portion 322aI is located on the longitudinal portion 226 which is arranged opposite the open side 252.

Preferably, oppositely arranged flange portions 322aII, 322aIII are arranged at least partially in contact with oppositely arranged longitudinal portions 222, 224 of the support element 212.

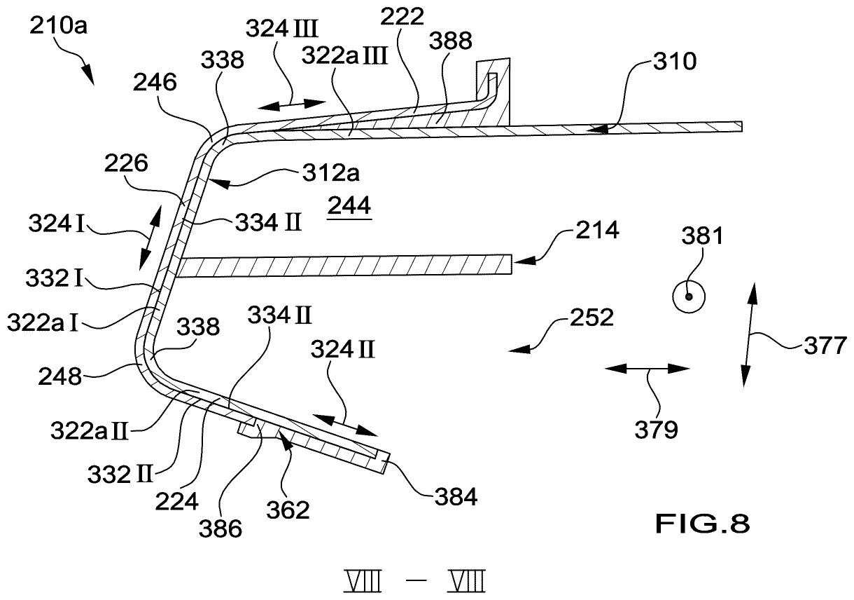

In some advantageous variants, at least one flange portion 322a is in contact with a longitudinal portion 222, 226, 224 over a large area, as is shown by way of example in FIG. 8 for the flange portions 332aI and 332aII as well as the longitudinal portions 226 and 224.

In some advantageous variants, at least one flange portion 322a is at least partially in contact with a longitudinal portion 222, 224, 226, as is shown by way of example in FIG. 8 for the flange portion 322aIII and the longitudinal portion 222.

In some other advantageous variants, at least two opposing flange portions 322a are in contact with a relevant portion of the support element 212 over a large area. The illustration in FIG. 8 is also intended to be representative of such variants.

In some variants, for example, at least one flange portion 322a is in contact with a curvature region 242 of the support element 212. Regarding advantageous embodiments thereof, full reference is made to the explanations in connection with the above-described exemplary embodiment and the further related explanations.

In particular, the functional element 310 includes further parts, for example at least one fastening part 316 and/or the functional element 310 forms at least a part of a functional unit. For advantageous embodiments thereof, full reference is made to the relevant explanations in connection with the above-described exemplary embodiment and the further relevant explanations.

An injection molding element 214 comprises at least one retaining part 362, wherein the retaining part 362 is at least partially molded onto the retaining part 312 and the support element 212. In particular, the retaining part 362 is at least partially molded onto the adjacently arranged portions of the retaining part 312 and the support element 212.

For example, the retaining part 362 has a retaining rib 382. An example of a retaining rib 382 is shown in FIG. 6. Advantageously, the retaining rib 382 holds the retaining part 312 at least partially in its position.

Advantageously, the retaining part 362 with positive-locking holding portions 384, 386 surrounds the retaining part 312 and/or a portion, in particular a longitudinal portion 222, 224, 226, of the support element 212.

In some advantageous variants, the retaining part 362 has at least one filling portion 388, through which a cavity between the retaining part 312 and the support element 212 is filled.

In particular, a box-like structure of the retaining part 312 and, for example, a box-like structure of at least further parts of the functional element 310 and, for example, of the entire functional element 310 is advantageous for a stable design of said functional element and/or for a stable attachment to the support element 212 and/or for a stable attachment of further elements and/or units to the functional element 310.

In particular, the ability of the retaining part 312 to reach into the inner region 244 of the support element 212 is advantageous during the manufacture of the vehicle body unit 210 for precise positioning of the retaining part 312. In particular, by the engagement of the retaining part 312 in the inner region 244 of the support element 212, a relative position between the retaining part 312 and the support element 212 can be determined in a plurality of spatial directions 377, 379, 381.

If flange portions 322 of the retaining part 312 arranged opposite each other are in contact with a relevant portion of oppositely arranged portions of the support element 212 over a large area, this is particularly advantageous because, in the spatial direction 377, 379, 381, in which the portions are arranged opposite each other, the relative position between the retaining part 312 and the support element 212 is particularly well fixed in both orientations of the spatial direction 377, 379, 381 in which the portions are arranged opposite each other.

If, of two opposing flange portions 322 of the retaining part 312, a flange portion 122 is only partially in contact with one of a plurality of opposing portions of the support element 212, this is particularly advantageous because larger tolerances can be permitted and, advantageously, any cavity that may be present between the retaining part 312 and the functional element 310 is filled through a filling portion 388 of an injection molding element 214.

As explained above, the at least partially adjacent arrangement of the retaining part 312 on the support element 212 is particularly advantageous for the manufacture of the vehicle body unit 210 and/or for the stable design thereof.

As explained above, the retaining part 362 of an injection molding element 214, which is at least partially molded onto the retaining part 312 and the support element 212, is advantageous in particular for the production of the vehicle body unit 210 and/or for the stable formation thereof, for example to at least determine the relative position between the functional element 310 and the support element 212 and in particular to hold the retaining part 312 together with the support element 212.

Particularly advantageous for holding things together is at least one retaining rib 382 and/or a surrounding of the retaining portions 384, 386 of the retaining part 362.

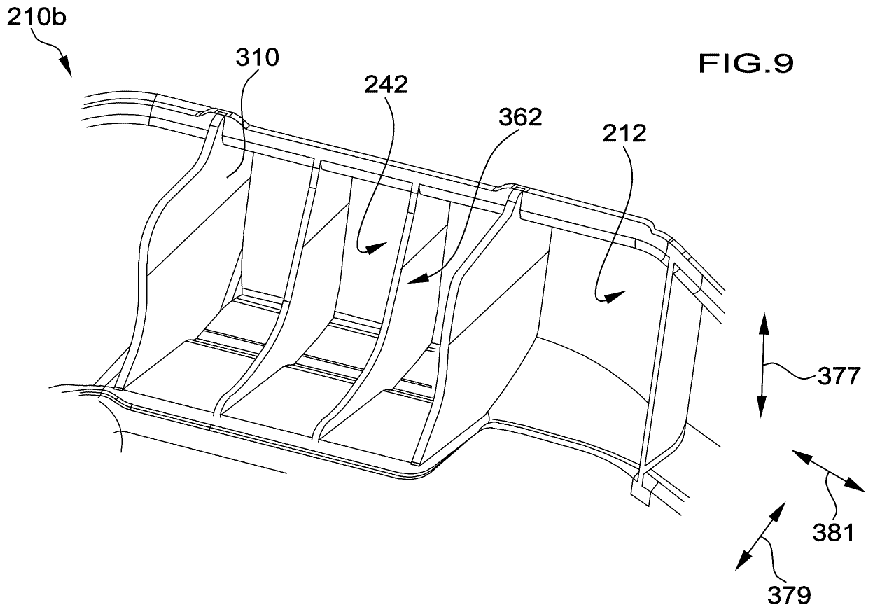

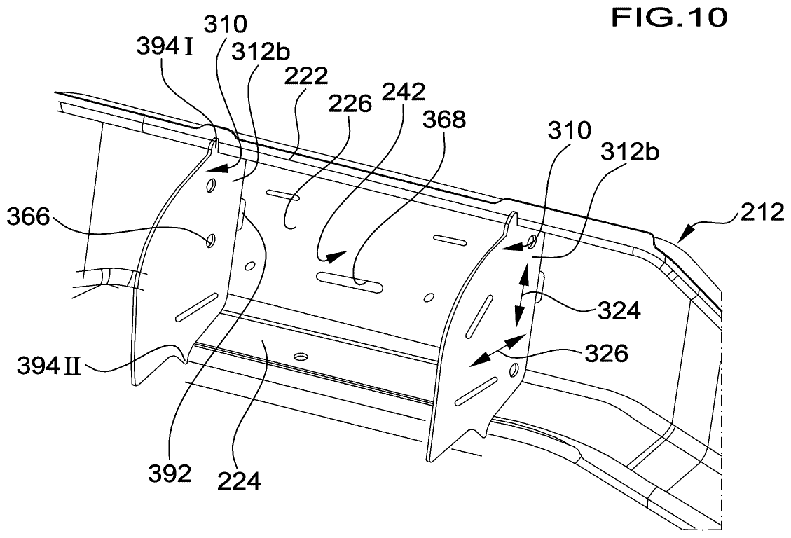

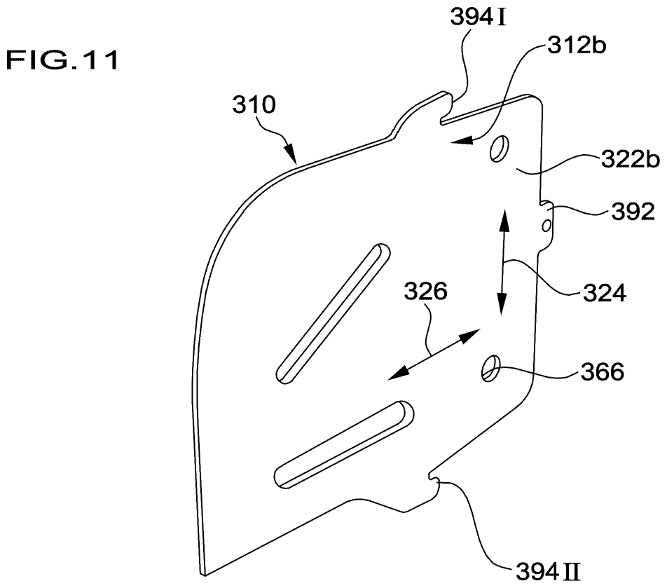

A further exemplary embodiment of a vehicle body unit 210b is shown by way of example in one variant in FIG. 9 to 11.

In particular, in this exemplary embodiment, a retaining part 312b of at least one functional element 310 comprises at least one thin portion extending over a large area in an expansion area, such that in this sense this portion is a flange portion 322b.

In some advantageous variants, the retaining part 312b is designed as a flange portion 322b and, in particular, the retaining part 312b forms at least substantially the entire functional element 310, as shown by way of example in FIG. 9 to 11.

In some advantageous variants, for example, the retaining part 312b comprises further portions and/or the functional element 310 comprises further parts. However, with regard to at least the adjacent arrangement and, for example, further designs and/or features of these variants, the exemplary illustrations in FIG. 9 to 11 are also representative of these variants.

In particular, the retaining part 312b extends, in particular with the flange portion 322b thereof, between two opposing longitudinal portions 222, 224 of the support element 212. In particular, one of the expansion directions 324, 326 which span the expansion area of the flange portion 322 runs in the direction in which the two longitudinal portions 222, 224 are arranged opposite each other. In particular, the retaining part 312 is arranged with one narrow side in contact with the support element 212.

In particular, at least one narrow side of the retaining part 312 forms a contact surface 332, and the contact surface 332 contacts the support element 212.

Advantageously, the retaining part 312b, in particular a narrow side thereof, is in contact with a longitudinal portion 226 of the support element 212, wherein this longitudinal portion 226 is arranged opposite the open side 252 of the support element 212.

Advantageously, the retaining part 312b has at least one positive-locking part 392, 394, wherein the positive-locking part 392, 394 interacts positively with the support element 212.

For example, a positive-locking part 392 is designed as a projection and engages in a corresponding positive-locking part of the support element 212. In particular, the corresponding positive-locking part is a recess in the support element 212. The recess has a shape corresponding to the positive-locking part 392, so that they interact in a positive-locking manner.

For example, a positive-locking part 394 is designed as a surrounding part which, for example, positively engages a longitudinal portion 222, 224, 226 of the support element 212.

In some advantageous variants of the other exemplary embodiments, at least one positive-locking part 392, 394 is provided as explained in connection with this exemplary embodiment.

In this exemplary embodiment, in particular, the vehicle body unit 210 also comprises at least one injection molding element 214, the retaining part 362 of which is at least partially formed on the functional element 310, in particular at least on the retaining part 312 thereof, and at least partially on the support element 212.

Advantageously, the retaining part 362 is formed over a large area on the flange portion 322b of the retaining part 312 and, in particular, is formed on the large-surface side of the flange portion 322b, which expands in the expansion area.

In particular, it is advantageous if at least the retaining part 312 is embedded in the retaining part 362.

Advantageously, the functional element 310, in particular the retaining part 312b thereof, has at least one recess 366 and/or the support element 212 has at least one recess 368, wherein the retaining part 362 of the injection molding element 214 engages in the at least one recess 366, 368 and, for example, extends through it.

In particular, an advantage of this exemplary embodiment is that the retaining part 312b extends between two opposing portions of the support element 212 and thereby advantageously increases the stability of the vehicle body unit 210b.

Advantageously, a relative position of the functional element 310 relative to the support element 212 is determined by extending the retaining part 312b between the two oppositely arranged portions of the support element 212 in the spatial direction 377 in which the two portions are arranged opposite each other in both orientations of this spatial direction 377.

It is particularly advantageous for the retaining part 312b to be attached to two opposite longitudinal portions 222, 224 of the support element 212 and to the longitudinal portion 226 connecting the two opposite longitudinal portions 222, 224. Advantageously, the relative position between the functional element 310 and the support element 212 is thus determined at least in one spatial direction 377 in both of its orientations and in at least one further spatial direction 379 in at least one orientation.

In particular, an advantage of positive-locking parts 392, 394 in the retaining part 312 and/or the support element 212 is that they interact positively, and thus, for example, a particularly stable fastening can be achieved and/or a relative position between the functional element 310 and the support element 212 can be determined particularly advantageously.

It is particularly advantageous if the relative position between the functional element 310 and the support element 212 is determined in a spatial direction 381 by at least one positive-locking part 392, 394, in this case in particular by the positive-locking part 392, wherein this spatial direction 381 runs transversely to at least one spatial direction 377, 379 in which the relative position between the functional element 310 and the support element 212 is determined by the contact between them.

For example, the relative position between the functional element 310 and the support element 212 in at least one spatial direction 377, 379, preferably in two spatial directions 377, 379, which run transversely to the component axis 218, is determined by their contact with each other, and the relative position in the axial direction to the component axis 218 is achieved by the positive-locking interaction of the positive-locking part 392 with the support element 212.

Some advantageous variants of the exemplary embodiments described above have features that have been explained in connection with at least one other exemplary embodiment.

In further exemplary embodiments, a vehicle body unit 210 has combinations of the features described above in connection with different exemplary embodiments.

### LIST OF REFERENCE SIGNS

110 vehicle body
112 vehicle longitudinal axis
114 forward region
116 forward crossmember
118 longitudinal member
122 central region
124 A-pillar support
126 windshield cross member
128 roof support structure
132 rear region
134 rear support structure
136 vehicle body substructure
138 vehicle longitudinal direction
142 interior
144 passenger compartment
146 engine compartment
148 trunk
152 cockpit region
154 front region
156 end face
210 vehicle body unit
212 support element
214 injection molding element
218 component axis
222 longitudinal portion
224 longitudinal portion
226 longitudinal portion
232 longitudinal end
234 longitudinal end
242 curvature region
244 inner region
246 connection region
248 connection region
252 open side
310 functional element
312 retaining part
316 fastening part
322 flange portion
324 direction of expansion
326 direction of expansion
332 contact surface of the retaining part
334 contact surface of the support element
338 mold-on region
352 force flow path
362 retaining part
366 recess in functional element
368 recess in support element
374 reinforcement part/reinforcement portion
376 fastening part
377 spatial direction
379 spatial direction
381 spatial direction
382 retaining rib
384 retaining portion
386 retaining portion
388 filling portion
392 positive-locking part
394 positive-locking part

What is claimed is:

1. A vehicle body unit (210) comprising:
a support element (212) extending longitudinally;
at least one injection molding element (214) and at least one functional element (310), wherein the at least one functional element (310) has a retaining part (312) and is arranged adjacent to and at least partially in contact with the support element (212); and
the at least one injection molding element (214) having at least one retaining part (362) and being at least partially molded onto the support element (212) and the at least one adjacently arranged functional element (310).

2. The vehicle body unit (210) according to claim 1, wherein the at least one functional element (310) is arranged with the retaining part (312) thereof in contact with the support element (212) along a force flow path (352) provided in the vehicle body unit (210).

3. The vehicle body unit (210) according to claim 1, wherein the at least one adjacent arrangement of the at least one functional element (310) on the support element (212) defines a relative position between the at least one functional element (310) and the support element (212) in at least one orientation of at least one spatial direction (377, 379, 381).

4. The vehicle body unit (210) according to claim 3, wherein at least one of the following is provided:
the relative position in at least two spatial directions (377, 379, 381) is determined by the adjacent arrangement in at least one orientation of the relevant spatial direction (377, 379, 381);
the relative position in three spatial directions (377, 379, 381) is determined by the adjacent arrangement in at least one orientation of the relevant spatial direction (377, 379, 381);
the relative position is determined by the adjacent arrangement in at least one spatial direction (377, 379, 381);
the relative position is determined by the adjacent arrangement in at least one spatial direction (377, 379, 381) in both orientations of the relevant spatial direction (377, 379,

381. ;
the relative position is determined by the adjacent arrangement in two spatial directions (377, 379, 381);
the relative position is determined by the adjacent arrangement in two spatial directions (377, 379, 381) in both orientations of the relevant spatial direction (377, 379, 381).

5. The vehicle body unit (210) according to claim 1, wherein the at least one functional element (310) is held relative to the support element (212) in at least one orientation in at least one spatial direction (377, 379, 381) by the at least one retaining part (362).

6. The vehicle body unit (210) according to claim 5, wherein the at least one functional element (310) is held by the at least one retaining part (362) in at least most of the at least one orientation of the at least one spatial direction (377, 379, 381) in which the relative position between the at least one functional element (310) and the support element (212) is not determined by the adjacent arrangement of the at least one functional element (310) and the support element (212).

7. The vehicle body unit (210) according to claim 5, wherein the at least one functional element (310) is held by the at least one retaining part (362) in all of the at least one orientation of the at least one spatial direction (377, 379, 381) in which the relative position between the at least one functional element (310) and the support element (212) is not determined by the adjacent arrangement of the at least one functional element (310) and the support element (212).

8. The vehicle body unit (210) according to claim 1, wherein the at least one functional element (310), with the retaining part (312) thereof, is arranged in contact with a curvature region (242) of the support element (212).

9. The vehicle body unit (210) according to claim 1, wherein at least one positive-locking part (392, 394) forms a positive lock between the at least one functional element (310) and the support element (212), the at least one functional element (310) being arranged in contact with the support element (212).

10. The vehicle body unit (210) according to claim 1, characterized by at least one of the following:
that the support element (212) has at least in portions an inner region (244);
that the support element (212) comprises a plurality of longitudinal portions (222, 224, 226), wherein the longitudinal portions (222, 224, 226) extend longitudinally, wherein two longitudinal portions (222, 224, 226) are spaced apart from each other transversely to their longitudinal extent, wherein at least two longitudinal portions (222, 224, 226) extend longitudinally at least approximately parallel to each other;
that at least in portions the inner region (244) of the support element (212) is defined between at least two longitudinal portions (222, 224, 226) of the support element (212);
that at least one further longitudinal portion (222, 224, 226) of the support element (212) connects the two spaced-apart longitudinal portions together;
that the support element (212) has at least in portions an open side (252), wherein the inner region (244) is open to the outside on the open side (252);
that the support element (212) is a C-profile.

11. The vehicle body unit (210) according to claim 1, characterized by at least one of the following:
that the support element (212) is at least partially made of a metallic material;
that the support element (212) is at least partially made of a material comprising a plastic material.

12. The vehicle body unit (210) according to claim 1, wherein the at least one functional element (310) is arranged with a flange portion (322) in contact with the support element (212).

13. The vehicle body unit (210) according to claim 1, wherein the at least one functional element (310) engages at least partially with the retaining part (312) thereof, in the support element (212).

14. The vehicle body unit (210) according to claim 10, wherein the at least one functional element (310) engages at least partially with the retaining part (312) thereof, in the inner region (244) of the support element (212).

15. The vehicle body unit (210) according to claim 1, wherein the at least one functional element (310) extends at least partially with the retaining part (312) thereof, between at least two portions of the support element (212).

16. The vehicle body unit (210) according to claim 15, wherein the at least one functional element (310) extends at least partially with the retaining part (312) thereof, between at least two longitudinal portions (222, 224, 226) of the support element (212).

17. The vehicle body unit (210) according to claim 1, wherein the at least one functional element (310) is arranged with the retaining part (312) thereof in contact with at least two longitudinal portions (222, 224, 226) of the support element (212).

18. The vehicle body unit (210) according to claim 1, wherein at least one contact surface (332) of an adjacently arranged portion of the at least one functional element (310) contacts at least one contact surface (334) of the support element (212).

19. The vehicle body unit (210) according to claim 1, wherein the at least one retaining part (362) of the at least one injection molding element (214) is molded onto at least the retaining part (312) and/or an adjacently arranged portion of the support element (212).

20. The vehicle body unit (210) according to claim 19, wherein the at least one retaining part (362) of the at least one injection molding element (214) is completely molded onto at least the retaining part (312) and/or the adjacently arranged portion of the support element (212).

21. The vehicle body unit (210) according to claim 1, wherein the at least one retaining part (362) embeds the retaining part (312) of the at least one functional element (310) completely.

22. The vehicle body unit (210) according to claim 1, wherein the at least one retaining part (362) engages at least the support element (212) and/or the at least one functional element (310) at least partially in a positive-locking manner.

23. The vehicle body unit (210) according to claim 15, wherein the at least one retaining part (362) engages at least the support element (212) and/or the retaining part (312) of the at least one functional element (310) at least partially in a positive-locking manner.

24. The vehicle body unit (210) according to claim 1, characterized by at least one of the following:
that the at least one retaining part (362) at least partially surrounds the support element (212) and/or the at least one functional element (310) in a positive-locking manner;
that the at least one retaining part (362) engages in at least one recess (366, 368) of the support element (212) and/or in at least one recess (366, 368) of the at least one functional element (310).

25. The vehicle body unit (210) according to claim 1, wherein the at least one injection molding element (214) is at least partially fiber-reinforced.

26. The vehicle body unit (210) according to claim 25, wherein the retaining part (362) of the molded on injection molding element (214) is at least partially fiber-reinforced.

27. The vehicle body unit (210) according to claim 1, wherein the at least one injection molding element (214) forms at least one reinforcing component for the support element (212) and/or for the at least one functional element (310).

28. The vehicle body unit (210) according to claim 1, wherein the at least one functional element (310) is at least partially made of a metallic material and is a metallic functional element (310).

29. The vehicle body unit (210) according to claim 1, wherein the at least one functional element (310) is designed as a fastening element for fastening a vehicle functional unit and/or for fastening a control unit and/or for fastening at least one further vehicle body component.

30. The vehicle body unit (210) according to claim 1, further comprising at least one further vehicle body component attached to the at least one functional element (310).

31. A vehicle body (110) for a vehicle, wherein the vehicle body (110) comprises at least one vehicle body unit (210) according to claim 1.

32. A motor vehicle, comprising at least one vehicle body unit (210) according to claim 1 and/or comprising a vehicle body (110) having at least one vehicle body unit (210) according to claim 1.

33. A body unit (210) for a motor vehicle, comprising a carrier element (212), an injection-molded element (214), and a functional element (310), wherein the carrier element (212) extends longitudinally, wherein the functional element (310) is positively engaged with the carrier element (212), wherein the injection-molded element (214) has a retaining component (362) that is molded onto the carrier element (212) and onto the functional element (310), and wherein the retaining component (362) holds the carrier element (212) and the functional element (310) together;
characterized in that the functional element (310) serves to attach a steering column and/or a control unit for controlling an air conditioning system and/or an audio system and/or a navigation system in the motor vehicle.
